(19) United States
(12) Patent Application Publication
(10) Pub. No.: US 2012/0108213 A1
(43) Pub. Date: May 3, 2012

(54) APPARATUS AND METHODS FOR COMMUNICATING AN OVER-THE-AIR ACTIONABLE MESSAGE

(75) Inventors: Kabir Suresh KASARGOD, San Diego, CA (US); Charles Stewart WURSTER, San Diego, CA (US); Sathish Subramaniam AMBLEY, San Diego, CA (US); Scott Fredric FAUERBACH, Dublin, OH (US); Brian E. Minear, San Diego, CA (US)

(73) Assignee: QUALCOMM INCORPORATED, San Diego, CA (US)

(21) Appl. No.: 13/287,664

(22) Filed: Nov. 2, 2011

Related U.S. Application Data
(60) Provisional application No. 61/409,943, filed on Nov. 3, 2010.

(51) Int. Cl. H04W 4/12; H04B 7/00; G06F 15/16; H04M 1/725

(52) U.S. Cl. 455/412.1; 455/68; 709/217

(57) ABSTRACT

Provided are exemplary apparatus and methods for transmitting an over-the-air actionable message. In an example, a mobile device includes a detector to identify an over-the-air actionable messaging command that has a destination device identifier corresponding to a second mobile device. The mobile device also includes a message converter to convert the over-the-air messaging command into the actionable message, which has a destination corresponding to the destination device identifier of the second mobile device. Further, the mobile device has a transmitter to transmit the actionable message over-the-air to the second mobile device.

### CLAIM OF PRIORITY UNDER 35 U.S.C. §119

The present application for patent claims priority to U.S. Provisional Application No. 61/409,943, entitled “APPARATUS AND METHODS OF TRANSMITTING AN OVER-THE-AIR ACTIONABLE MESSAGE”, filed Nov. 3, 2010, and assigned to the assignee hereof and hereby expressly incorporated by reference herein.

### FIELD OF DISCLOSURE

This disclosure relates generally to electronics, and more specifically, but not exclusively, to apparatus and methods for communicating an over-the-air actionable message.

### BACKGROUND

Conventionally, operators of small wireless carrier networks are not connected to large messaging service aggregators. This lack of connection makes it difficult for users of the large messaging service aggregators to send over-the-air actionable messages to the users of small wireless carrier networks.

Accordingly, there are long-felt industry needs for methods and apparatus that improve upon conventional methods and apparatus, including apparatus and methods for transmitting an over-the-air actionable message.

### SUMMARY

This summary provides a basic understanding of some aspects of the present teachings. This summary is not exhaustive in detail, and is neither intended to identify all critical features, nor intended to limit the scope of the claims.

Exemplary methods and apparatus for communicating an actionable message are provided. An exemplary method includes detecting, at a first mobile device, an over-the-air actionable messaging command having a destination device identifier corresponding to a second mobile device. The method also includes converting the over-the-air actionable messaging command into the actionable message having a destination corresponding to the destination device identifier of the second mobile device. The converting can include converting the over-the-air messaging command from a server format message to the actionable message, where the actionable message has a source identifier corresponding to a phone number of the first mobile device. Further, the method includes transmitting the actionable message over-the-air to the second mobile device. The transmitting can include wirelessly transmitting the actionable message to a wireless network carrier actionable messaging server of a wireless network carrier associated with the second mobile device, where the wireless network carrier actionable message server is unaffiliated with an actionable messaging service aggregator. A polling message can be transmitted to inquire whether a request message calling for the actionable message exists, when the over-the-air actionable messaging command is a response to the polling message. The over-the-air messaging command can represent a request received at an application download server. Moreover, the over-the-air messaging command can represent an application download request wirelessly received at an application download server from a browser client.

In a further example, provided is a non-transitory computer-readable medium, comprising instructions stored thereon that, if executed by a processor, cause the processor to execute at least a part of the aforementioned method. The non-transitory computer-readable medium can be integrated with a device, such as a mobile device, a terminal, a subscriber unit, a communications device, a personal digital assistant (PDA), and/or a computer.

In another example, provided is an apparatus configured to communicating an actionable message. The apparatus includes means for detecting, at a first mobile device, an over-the-air actionable messaging command having a destination device identifier corresponding to a second mobile device. The apparatus also includes means for converting the over-the-air actionable messaging command into the actionable message having a destination corresponding to the destination device identifier of the second mobile device, as well as means for transmitting the actionable message over-the-air to the second mobile device. The means for converting can also include means for converting the over-the-air messaging command from a server format message to the actionable message, where the actionable message comprises has a source identifier corresponding to a phone number of the first mobile device. The apparatus can also include means for transmitting a polling message to inquire whether a request message calling for the actionable message exists, wherein the over-the-air actionable messaging command is a response to the polling message. The means for transmitting can include wirelessly transmitting the actionable message to a wireless network carrier actionable messaging server of a wireless network carrier associated with the second mobile device, where the wireless network carrier actionable message server is unaffiliated with an actionable messaging service aggregator. The over-the-air messaging command can represent a request received at an application download server. The over-the-air messaging command can represent an application download request wirelessly received at an application download server from a browser client.

At least a part of the apparatus can be integrated on a semiconductor die. Further, at least a part of the apparatus can be integrated with a device, such as a mobile device, a terminal, a subscriber unit, a communications device, a personal digital assistant (PDA), and/or a computer. In a further example, provided is a non-transitory computer-readable medium, comprising instructions stored thereon that, if executed by a lithographic device, cause the lithographic device to fabricate at least a part of the apparatus.

In another example, provided is a mobile device configured to communicate an actionable message. The apparatus includes a detector having a detecting function to identify an over-the-air actionable messaging command having a destination device identifier corresponding to a second mobile device. The mobile device also includes a message converter having a conversion function to convert the over-the-air messaging command into the actionable message having a destination corresponding to the destination device identifier of the second mobile device. The message converter can further convert the over-the-air messaging command from a server format message to an actionable message comprising a mobile-to-mobile format having a source identifier corresponding to a phone number of the mobile device. Further, the mobile device includes a transmitter to transmit the actionable message over-the-air for delivery to the second mobile device. The transmitter can further wirelessly transmit the actionable message to a wireless network carrier actionable messaging server of a wireless network carrier associated with the second mobile device, where the wireless network carrier actionable message server is unaffiliated with an actionable messaging service aggregator. The mobile device can also include a polling component having a function to transmit a polling message to inquire whether a request message exists calling for the actionable message, where the over-the-air actionable messaging command is in response to the polling message. The over-the-air messaging command can represents a request received at an application download server. The over-the-air messaging command can represents an application download request wirelessly received at an application download server from a browser client.

At least a part of the mobile device can be integrated on a semiconductor die. In a further example, provided is a non-transitory computer-readable medium, comprising instructions stored thereon that, if executed by a lithographic device, cause the lithographic device to fabricate at least a part of the mobile device.

The foregoing broadly outlines some of the features and technical advantages of the present teachings in order that the detailed description and drawings can be better understood. Additional features and advantages are also described in the detailed description. The conception and disclosed embodiments can be readily utilized as a basis for modifying or designing other structures for carrying out the same purposes of the present teachings. Such equivalent constructions do not depart from the technology of the teachings as set forth in the claims. The novel features that are characteristic of the teachings, together with further objects and advantages, are better understood from the detailed description and the accompanying figures. Each of the drawings are provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an exemplary schematic diagram of an over-the-air actionable messaging system.

FIG. 2 depicts an exemplary block diagram of logical components of an interim mobile device operable in an over-the-air actionable messaging system.

FIG. 3 depicts an exemplary flow chart of a method for actionable messaging.

FIG. 4 depicts an exemplary message flow diagram of a message flow associated with an over-the-air actionable messaging system.

FIG. 5 depicts an exemplary block diagram of logical components of an actionable messaging apparatus operable in an over-the-air actionable messaging system.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Methods and apparatus for communicating an over-the-air actionable message are provided. The described examples convert a mobile device into an over-the-air actionable messaging gateway, thereby enabling a server to send an actionable message to a mobile device without requiring back-end integration with a messaging aggregator.

In an example, a mobile device includes a detector to identify an over-the-air actionable messaging command that has a destination device identifier corresponding to a second mobile device. The mobile device also includes a message converter to convert the over-the-air messaging command into the actionable message, which has a destination corresponding to the destination device identifier of the second mobile device. Further, the mobile device has a transmitter to transmit the actionable message over-the-air to the second mobile device.

An advantage provided by the exemplary apparatuses and methods disclosed herein is an improvement in service provided to users of wireless networks over conventional devices.

Examples of the current teachings are disclosed in this application's text and drawings. The examples advantageously address the long-felt industry needs, as well as other previously unidentified needs, and mitigate shortcomings of the conventional methods and apparatus. Alternate embodiments can be devised without departing from the scope of the invention. Additionally, conventional elements of the current teachings may not be described in detail, or may be omitted, to avoid obscuring aspects of the current teachings.

The word “exemplary” is used herein to mean “serving as an example, instance, or illustration.” Any embodiment described as “exemplary” is not necessarily to be construed as preferred or advantageous over other embodiments. Likewise, the term “embodiments of the invention” does not require that all embodiments of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures.

It should be noted that the terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As employed herein two elements can be considered to be “connected” or “coupled” together by the use of one or more wires, cables, and/or printed electrical connections, as well as by the use of electromagnetic energy, such as electromagnetic energy having wavelengths in the radio frequency region, the microwave region and/or the optical (both visible and invisible) region, as several non-limiting and non-exhaustive examples.

It should be understood that the term “signal” can include any signal such as a data signal, audio signal, video signal, multimedia signal. Information and signals can be represented using any of a variety of different technologies and techniques. For example, data, instructions, process step, commands, information, signals, bits, symbols, and chips that can be referenced throughout this description can be represented by voltages, currents, electromagnetic waves, magnetic fields or particles, optical fields or particles, and/or any combination thereof.

It should be understood that any reference to an element herein using a designation such as “first,” “second,” and so forth does not generally limit the quantity or order of those elements. Rather, these designations can be used herein as a convenient method for distinguishing between two or more elements or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims means “A or B or C or any combination of these elements.”

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Furthermore, various examples are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various examples are described herein in connection with a base station. A base station can be utilized for communicating with wireless terminal(s) and can also be referred to as an access point, a Node B, or some other terminology. Moreover, the term “mobile device” includes, but is not limited to, a mobile phone, a mobile communication device, personal digital assistant, mobile palm-held computer, a wireless device, and/or other types of portable electronic devices typically carried by a person and/or having some form of communication capabilities (e.g., wireless, infrared, short-range radio, etc.).

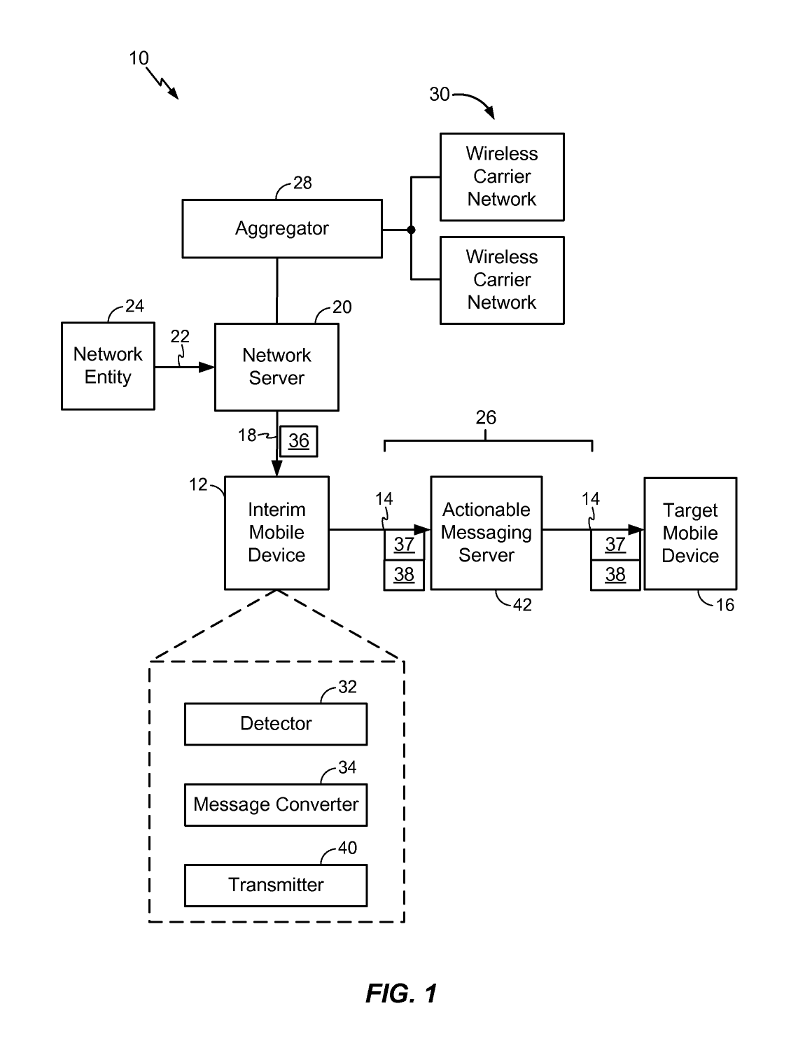

FIG. 1 depicts an exemplary actionable messaging system 10 including an interim mobile device 12 acting as an actionable messaging gateway to generate an over-the-air actionable message 14 destined for a target mobile device 16. For example, the over-the-air actionable message 14 is generated in response to receiving an over-the-air actionable messaging command 18 from a network server 20. The network server 20 generates the over-the-air actionable messaging command 18 in response to receiving a request message 22 from another entity, such as a browser client and/or network entity 24. The network server 20 can be an application download server, and network entity 24 can be a computer having a browser client that generates a request to download an application to the target mobile device 16. Further, in this case, the target mobile device 16 is a subscriber to a wireless carrier network 26 that is not affiliated with an actionable messaging aggregator service 28 that serves a plurality of other wireless carrier networks 30.

Accordingly, the interim mobile device 12 includes a detector 32 having a detecting function to identify the over-the-air actionable messaging command 18 and a message converter 34 having a conversion function to convert the over-the-air actionable messaging command 18 into the over-the-air actionable message 14. In particular, in an example, the over-the-air actionable messaging command 18 is a message in a server format, including at least a destination device identifier 36, which the message converter 34 converts into the over-the-air actionable message 14. The over-the-air actionable message 14 has a mobile-to-mobile format, including a source identifier 37 corresponding to a phone number of the interim mobile device 12, as well as a destination identifier 38 corresponding to (or the same as) the destination device identifier 36 of target mobile device 16. Further, the interim mobile device 12 includes a transmitter 40 to transmit the over-the-air actionable message 14 over-the-air to the target mobile device 16. In an example, the transmitter 40 wirelessly transmits the over-the-air actionable message 14 to a wireless network carrier actionable messaging server 42 of the wireless carrier network 26 associated with the target mobile device 16, where the wireless network carrier actionable messaging server 42 is unaffiliated with (i.e., not part of the same subscriber network as) actionable messaging aggregator service 28.

As used herein, the term “over-the-air” refers to a wireless communication link. Moreover, the term “interim” with respect to “interim mobile device 12” refers to a mobile device configured to intervene between the network server 20 and the wireless network carrier actionable messaging server 42, providing an interface to communicate the over-the-air actionable message 14 from the network server 20 to the target mobile device 16. In particular, the over-the-air actionable message 14 includes the source identifier 37 corresponding to the phone number of the interim mobile device 12. The phone number can be used as the source identifier in place of a short code, where the short code designates, for example, a web service or another network service different from a mobile device. Additionally, in an example, the over-the-air actionable message 14 and the over-the-air actionable messaging command 18 can be, and/or can include, a command sent from a server to a mobile device and/or from a first mobile device to a second mobile device (e.g., the interim mobile device 12 to the target mobile device 16). The over-the-air actionable message 14 can trigger the receiving mobile device to launch a designated application, and can trigger the receiving mobile device to use data included with the command. Thus, in the actionable messaging system 10, the interim mobile device 12 is an actionable messaging gateway to the wireless network carrier actionable messaging server 42 and the target mobile device 16.

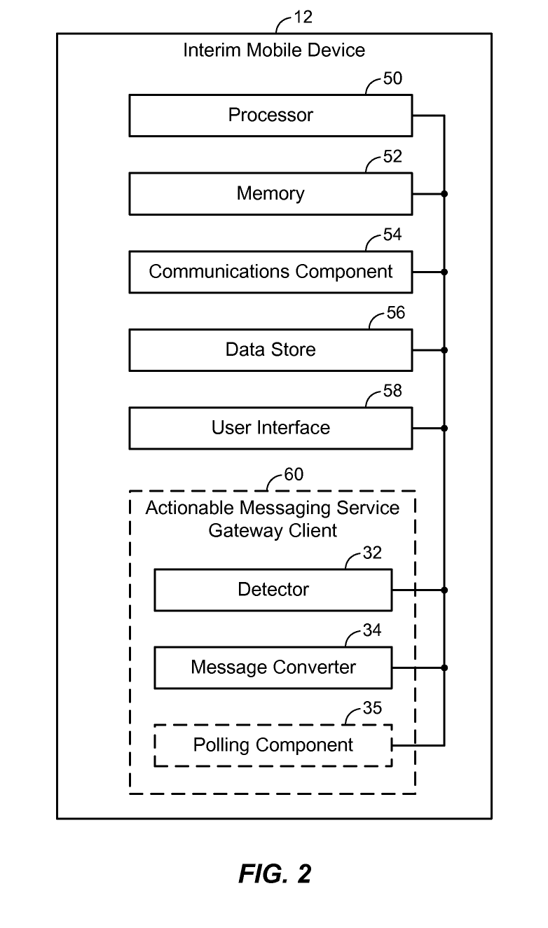

FIG. 2 depicts an exemplary interim mobile device 12 including a processor 50 configured to perform functions described herein. The processor 50 can be implemented as an integrated processing system and/or a distributed processing system.

The interim mobile device 12 further includes a memory 52, such as for storing local versions of applications and/or data being processed by the processor 50. The memory 52 can include any type of memory usable by a computer, such as random access memory (RAM), read only memory (ROM), tapes, magnetic discs, optical discs, volatile memory, non-volatile memory, and any combination thereof.

Further, the interim mobile device 12 includes a communications component 54 (e.g., a transceiver circuit) establishes and maintaining communications with one or more communication devices. The interim mobile device 12 uses hardware, software, and services as described herein to establish and maintain the communications. The communications component 54 can carry communications between components in the interim mobile device 12, as well as between the interim mobile device 12 and external devices. The external devices can include devices located in a communications network, such as the network server 20, the wireless network carrier actionable messaging server 42, the target mobile device 16, and/or devices connected to the interim mobile device 12. For example, the communications component 54 can include one or more buses. The communications component 54 can include transmit chain components and receive chain components associated with and/or including a transmitter and receiver that can interface with external devices.

Additionally, the interim mobile device 12 can further include a data store 56 (e.g., a data memory), which can be any suitable combination of hardware and/or software that stores information, databases, and/or programs used in connection with examples described herein. For example, the data store 56 can be a data repository for applications not concurrently executed by the processor 50, such applications requiring the detector 32 and the message converter 34.

The interim mobile device 12 can additionally include a user interface component 58 operable to receive an input from a user of the interim mobile device 12, and further operable to present an output to the user. The user interface component 58 can include one or more input devices, including but not limited to, a keyboard, a number pad, a mouse, a touch-sensitive display, a navigation key, a function key, a microphone, a voice recognition component, any other mechanism capable of receiving an input from a user, and any combination thereof. Further, the user interface component 58 can include one or more output devices, including but not limited to, a display, a speaker, a haptic feedback mechanism, a printer, any other mechanism capable of presenting an output to a user, and any combination thereof.

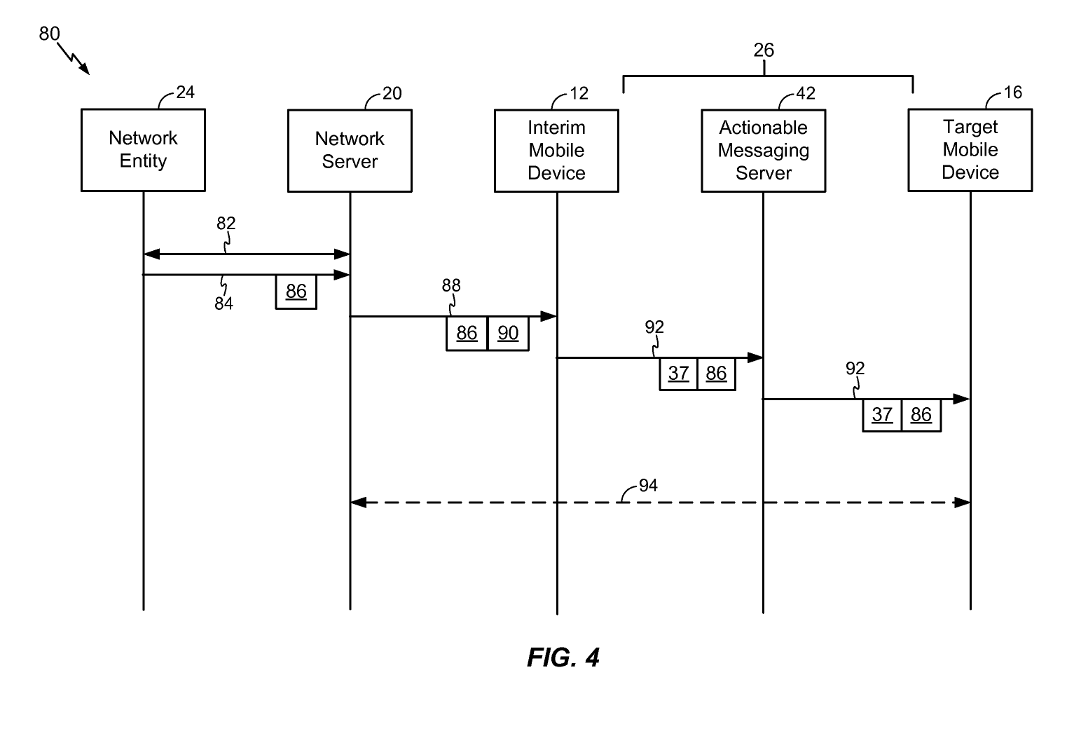

Additionally, in examples, the interim mobile device 12 can include the detector 32 and the message converter 34, as described above. In an example, the detector 32 and the message converter 34 can define an actionable messaging service gateway client 60 programmed on interim mobile device 12. In an example, the actionable messaging service gateway client 60 can include the polling component 35 to generate and transmit a polling message to the network server 20 to ask if the request message 22 that calls for the generation and transmission of the over-the-air actionable message 14 has been received. For example, in response to the polling message, the network server 20 sends the over-the-air actionable messaging command 18. In this polling example, the over-the-air actionable messaging command 18 sent to the interim mobile device 12 by the network server 20 does not necessarily include a command, but can include message parameters 86, such as a destination and/or target device identifier and an item identifier of an application to be downloaded, as depicted in FIG. 4.

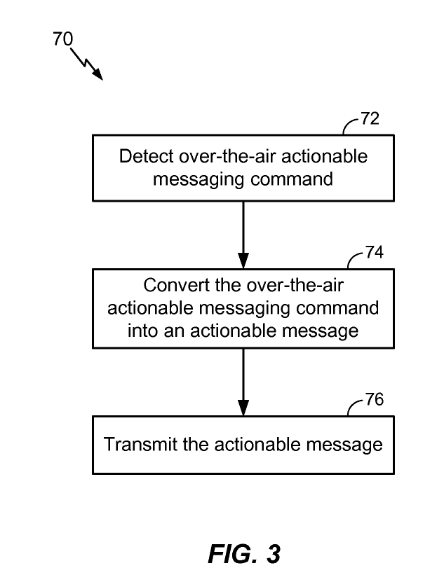

FIG. 3 depicts an exemplary method 70 for communicating an actionable message, and FIG. 4 depicts a message flow 80 of the exemplary method 70. In FIG. 3, an exemplary method 70 comprises detecting, at a first mobile device, an over-the-air actionable messaging command having a destination device identifier corresponding to a second mobile device (Block 72). For example, referring to FIG. 4, a message flow 80 includes the network server 20, such as an application download server, having a communication exchange 82 with the network entity 24, such as a browser client on a computer device. For example, the communication exchange 82 can involve exchanging information relating to applications that can be downloaded from the network server 20 to the target mobile device 16, resulting in a request message 84 transmitted from the network entity 24 to the network server 20. The request message 84 can include message parameters 86 such as, but not limited to, a destination identifier corresponding to the target mobile device 16 and an application identifier and/or action instructions corresponding to a desired application to be downloaded. In response to receiving the request message 84, the network server 20 generates and transmits the message parameters 86 to the interim mobile device 12. In an example, the network server 20 includes a destination determiner that determines, based on the message parameters 86 (e.g., a destination identifier), that the target mobile device 16 is a subscriber to the wireless carrier network 26 and is not affiliated with the actionable messaging aggregator service 28. Accordingly, a command generator component of the network server 20 creates an over-the-air command message 88, which includes an over-the-air actionable messaging command 90 that is detectable by the actionable messaging service gateway client 60 and/or the detector 32 of the interim mobile device 12. Moreover, in an example, the command message 88 can additional include all or a portion of the message parameters 86, and/or a representation thereof.

Further, referring to FIG. 3, the method 70 includes converting the over-the-air actionable messaging command into the actionable message having a destination corresponding to the destination device identifier of the second mobile device (Block 74). For example, referring to FIG. 4, a receiver portion of the communications component 54 of the interim mobile device 12 receives the command message 88. The actionable messaging service gateway client 60 and/or the detector 32 determines a presence of the actionable messaging command 90. In response thereto, the actionable messaging service gateway client 60 and/or the message converter 34 transforms the command message 88 into a mobile-to-mobile formatted actionable message 92, which includes the source identifier 37 corresponding to a phone number of the interim mobile device 12. In an example, the mobile-to-mobile formatted actionable message 92 can include all or a portion of the message parameters 86, and/or a representation thereof.

Additionally, referring to FIG. 3, the method 70 includes transmitting the actionable message over-the-air to the second mobile device (Block 76). For example, referring to FIG. 4, a transmitter portion of the communications component 54 of the interim mobile device 12 transmits the mobile-to-mobile formatted actionable message 92 to the wireless network carrier actionable messaging server 42, which then forwards the mobile-to-mobile formatted actionable message 92 to the target mobile device 16. In an example, the mobile-to-mobile formatted actionable message 92 includes at least a portion or representation of the message parameters 86 of the request message 84, as well as the source identifier 37 corresponding to a phone number of the interim mobile device 12. As such, in one example, receipt of the mobile-to-mobile formatted actionable message 92 by the target mobile device 16 triggers an application acquisition client on the target mobile device 16 to launch and to download the desired application, (e.g., as can be identified by the message parameters 86) from the network server 20 or another application download server, as represented by the mobile-to-mobile formatted actionable message 92.

In one example of a use case, which should not be construed as limiting, the over-the-air command message 88 can have the following format in a binary runtime environment for wireless (BREW) operating system available from Qualcomm, Incorporated, of San Diego, Calif.: //vivesmsfwd:Phone=<phone #>, ItemID=<itemID>, where “vivesmsfwd” is the over-the-air actionable messaging command 90 (e.g., an identifier of what target application to launch, such as an application “vive” in the BREW), where “Phone=<phone #>” is a phone identification field and corresponding phone identification value, respectively (e.g., to identify the target mobile device 16 as the destination), and where “ItemID=<itemID>” is an item identification field and corresponding item identification value (e.g., to identify an application to download from a server). In this case, “Phone=<phone #>” and “ItemID=<itemID>” are data for use by the launched application, and can also be the message parameters 86. Further, in this example, the detector 32 recognizes the syntax of the command “vivesmsfwd” and executes the command by creating, via message converter 34 (e.g., the identified target application), the new mobile-to-mobile actionable message 92 having the following format: //cmshop:ItemID=<itemID>, where “cmshop” represents the target application identifier to launch a target application on the target mobile device 16 (e.g., the “CMSHOP” application in BREW), and where “ItemID=<itemID>” is the item identification field and corresponding item identification value. Further, the interim mobile device 12 subsequently transmits the new mobile-to-mobile actionable message 92, via the transmitter 40, from the interim mobile device 12 to the target mobile device 16 (e.g., the destination of the original request message 84). When the target mobile device 16 receives the new command (e.g., //cmshop.), the target mobile device 16 executes the command upon receipt. It should be noted that, in an example, more than one of the interim mobile device 12 can be utilized as the actionable messaging service gateway client 60, for example by utilizing the above-described method to create a daisy chain of the interim mobile devices 12, each of which are capable of forwarding the mobile-to-mobile formatted actionable message 92 before reaching the target mobile device 16. The exact formatting of the above-described messages can be different when using different operating systems (e.g., JAVA, ANDROID, etc.).

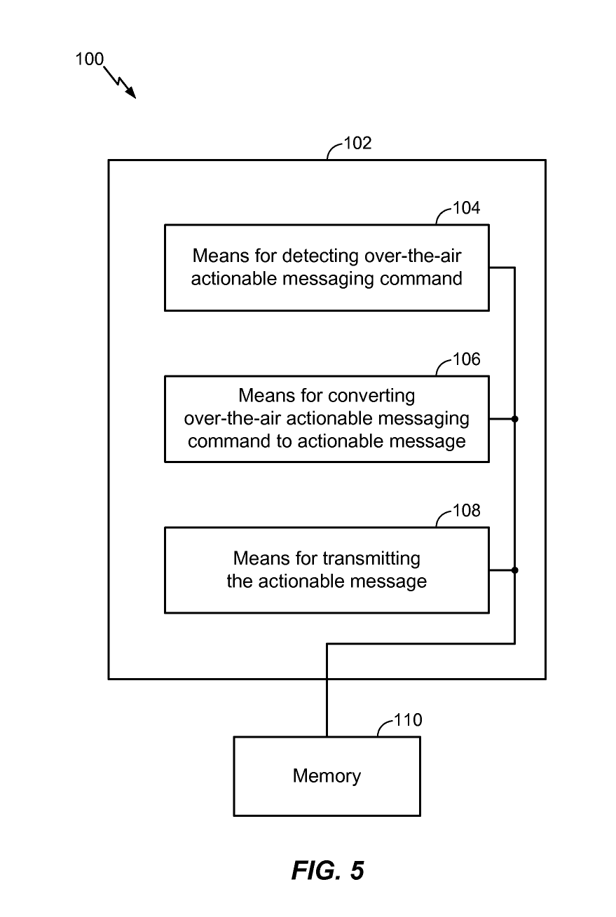

FIG. 5 depicts an apparatus 100 for communicating actionable messages, and can reside at least partially within a mobile device, such as a cellular telephone in a wireless communications network. The apparatus 100 can include, or be a portion of, the interim mobile device 12. The apparatus 100 includes functional blocks, which can be functional blocks that represent functions implemented by a processor, software, and/or a combination thereof (e.g., firmware). The apparatus 100 includes a group 102 of electrical components that act in conjunction. For instance, the group 102 can include means for detecting an over-the-air actionable messaging command having a destination device identifier corresponding to a second mobile device (Block 104). The means for detecting 104 can include the detector 32 of the interim mobile device 12. The means for detecting 104 can also include the processor 50 acting in conjunction with the communications component 54. Further, the group 102 can include means for converting the over-the-air messaging command into an actionable message having a destination corresponding to the destination device identifier of the second mobile device (Block 106). For example, the means for converting 106 can include the message converter 34. The means for converting 106 can include the processor 50 acting in conjunction with message converter 34. Additionally, the group 102 can include means for transmitting the actionable message over-the-air to the second mobile device (Block 108). The means for transmitting 108 can include the interim mobile device 12 and/or the message converter 34. The means for transmitting 108 can include one or some combination of the communications component 54, or a portion thereof such as a transmitter, the processor 50 and/or the actionable messaging service gateway client 60. In an example, the apparatus 100 can include at least one processor or one or more modules of a processor operable to perform the functions described herein.

Additionally, the apparatus 100 can include a memory 110 to retain instructions for executing functions of the group 102. The memory 110 can include the memory 52 and/or the data store 56.

Those of skill in the art will appreciate that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present invention.

In some examples, the teachings herein can be employed in a multiple-access system capable of supporting communication with multiple users by sharing the available system resources (e.g., by specifying one or more of bandwidth, transmit power, coding, interleaving, and so on). For example, the teachings herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain examples of the disclosure can be described using 3GPP terminology, it is to be understood that the teachings herein can be applied to 3GPP (e.g., Re199, Re15, Re16, Re17) technology, as well as 3GPP2 (e.g., 1xRTT, 1xEV-DO RelO, RevA, RevB) technology and other technologies. The techniques can be used in emerging and future networks and interfaces, including Long Term Evolution (LTE).

At least a portion of the methods, sequences and/or algorithms described in connection with the embodiments disclosed herein can be embodied directly in hardware, in a software module executed by a processor, or in a combination of the two. In an example, a processor includes multiple discrete hardware components. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor.

Further, many embodiments are described in terms of sequences of actions to be performed by, for example, elements of a computing device. It will be recognized that various actions described herein can be performed by a specific circuit (e.g., an application specific integrated circuit (ASIC), a combination of discrete components, etc.), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention can be embodied in a number of different forms, all of which have been contemplated to be within the scope of the claimed subject matter. In addition, for each of the embodiments described herein, a corresponding circuit of any such embodiments can be described herein as, for example, “logic configured to” perform a described action.

An embodiment of the invention can include a computer readable media embodying a method described herein. Accordingly, the invention is not limited to illustrated examples and any means for performing the functionality described herein are included in embodiments of the invention.

The disclosed apparatus and methods can be designed and can be configured in a computer file (e.g., a GDSII and/or a GERBER file) that is stored on a computer readable media. This file is in turn provided to a fabrication handler who fabricates a device, based on the file, with a lithographic device. The resulting product is a semiconductor wafer that can be cut into semiconductor dies and packaged into semiconductor chips. The semiconductor chips can be employed in devices described hereby.

Embodiments can include a machine-readable media and/or a computer-readable media embodying instructions which, when executed by a processor, transform a processor and any other cooperating devices into a machine for performing a function described hereby.

Nothing that has been stated or illustrated is intended to cause a dedication of any component, step, feature, object, benefit, advantage, or equivalent to the public, regardless of whether it is recited in the claims. While this disclosure describes exemplary embodiments of the invention, it should be noted that various changes and modifications could be made herein without departing from the scope of the invention as defined by the appended claims.

What is claimed is:

1. A method for communicating an actionable message, comprising:
detecting, at a first mobile device, an over-the-air actionable messaging command having a destination device identifier corresponding to a second mobile device;
converting the over-the-air actionable messaging command into the actionable message having a destination corresponding to the destination device identifier of the second mobile device; and
transmitting the actionable message over-the-air to the second mobile device.

2. The method of claim 1, further comprising transmitting a polling message to inquire whether a request message calling for the actionable message exists, wherein the over-the-air actionable messaging command is a response to the polling message.

3. The method of claim 1, wherein the over-the-air messaging command represents a request received at an application download server.

4. The method of claim 3, wherein the over-the-air messaging command represents an application download request wirelessly received at the application download server from a browser client.

5. The method of claim 1, wherein the converting comprises converting the over-the-air actionable messaging command from a server format message to the actionable message, wherein the actionable message has a source identifier corresponding to a phone number of the first mobile device.

6. The method of claim 1, wherein the transmitting comprises wirelessly transmitting the actionable message to a wireless network carrier actionable messaging server of a wireless network carrier associated with the second mobile device, wherein the wireless network carrier actionable messaging server is unaffiliated with an actionable messaging service aggregator.

7. An apparatus for communicating an actionable message, comprising:
means for detecting, at a first mobile device, an over-the-air actionable messaging command having a destination device identifier corresponding to a second mobile device;
means for converting the over-the-air actionable messaging command into the actionable message having a destination corresponding to the destination device identifier of the second mobile device; and
means for transmitting the actionable message over-the-air to the second mobile device.

8. The apparatus of claim 7, further comprising means for transmitting a polling message to inquire whether a request message calling for the actionable message exists, wherein the over-the-air actionable messaging command is a response to the polling message.

9. The apparatus of claim 7, wherein the over-the-air messaging command represents a request received at an application download server.

10. The apparatus of claim 9, wherein the over-the-air messaging command represents an application download request wirelessly received at the application download server from a browser client.

11. The apparatus of claim 7, wherein the means for converting comprises means for converting the over-the-air actionable messaging command from a server format message to the actionable message, wherein the actionable message has a source identifier corresponding to a phone number of the first mobile device.

12. The apparatus of claim 7, wherein the means for transmitting comprises wirelessly transmitting the actionable message to a wireless network carrier actionable messaging server of a wireless network carrier associated with the second mobile device, wherein the wireless network carrier actionable messaging server is unaffiliated with an actionable messaging service aggregator.

13. The apparatus of claim 7, wherein at least a part of the apparatus is integrated on a semiconductor die.

14. The apparatus of claim 7, further comprising at least one of a base station and a terminal, with which at least a part the apparatus is integrated.

15. A non-transitory computer-readable medium, comprising instructions stored thereon that, if executed by a processor, cause the processor to execute a method comprising:
detecting, at a first mobile device, an over-the-air actionable messaging command having a destination device identifier corresponding to a second mobile device;
converting the over-the-air actionable messaging command into an actionable message having a destination corresponding to the destination device identifier of the second mobile device; and
transmitting the actionable message over-the-air to the second mobile device.

16. The non-transitory computer-readable medium of claim 15, wherein the method further comprises transmitting a polling message to inquire whether a request message calling for the actionable message exists, wherein the over-the-air actionable messaging command is a response to the polling message.

17. The non-transitory computer-readable medium of claim 15, wherein the over-the-air messaging command represents a request received at an application download server.

18. The non-transitory computer-readable medium of claim 17, wherein the over-the-air messaging command represents an application download request wirelessly received at the application download server from a browser client.

19. The non-transitory computer-readable medium of claim 15, wherein the converting comprises converting the over-the-air actionable messaging command from a server format message to the actionable message, wherein the actionable message has a source identifier corresponding to a phone number of the first mobile device.

20. The non-transitory computer-readable medium of claim 15, wherein the transmitting comprises wirelessly transmitting the actionable message to a wireless network carrier actionable messaging server of a wireless network carrier associated with the second mobile device, wherein the wireless network carrier actionable messaging server is unaffiliated with an actionable messaging service aggregator.

21. The non-transitory computer-readable medium of claim 15, further comprising at least one of a base station and a terminal, with which the non-transitory computer-readable medium is integrated.

22. A mobile device configured to communicate an actionable message, comprising:
a detector having a detecting function to identify an over-the-air actionable messaging command having a destination device identifier corresponding to a second mobile device;
a message converter having a conversion function to convert the over-the-air actionable messaging command into the actionable message having a destination corresponding to the destination device identifier of the second mobile device; and
a transmitter to transmit the actionable message over-the-air for delivery to the second mobile device.

23. The mobile device of claim 22, further comprising a polling component having is configured to transmit a polling message to inquire whether a request message exists calling for the actionable message, wherein the over-the-air actionable messaging command is in response to the polling message.

24. The mobile device of claim 22, wherein the over-the-air messaging command represents a request received at an application download server.

25. The mobile device of claim 24, wherein the over-the-air messaging command represents an application download request wirelessly received at the application download server from a browser client.

26. The mobile device of claim 22, wherein the message converter further converts the over-the-air actionable messaging command from a server format message to the actionable message comprising a mobile-to-mobile format having a source identifier corresponding to a phone number of the mobile device.

27. The mobile device of claim 22, wherein the transmitter further wirelessly transmits the actionable message to a wireless network carrier actionable messaging server of a wireless network carrier associated with the second mobile device, wherein the wireless network carrier actionable messaging server is unaffiliated with an actionable messaging service aggregator.

28. The mobile device of claim 22, wherein at least a part of the mobile device is integrated on a semiconductor die.
